(19) United States
(12) Patent Application Publication
(10) Pub. No.: US 2013/0134906 A1
(43) Pub. Date: May 30, 2013

(54) NETWORK OF SYNCHRONOUS SELF-CONTAINED LIGHT BEACONS

(71) Applicant: Michel Picariello, Saint-Orens (FR)

(72) Inventor: Michel Picariello, Saint-Orens (FR)

(21) Appl. No.: 13/701,808

(22) PCT Filed: Jun. 6, 2011
(86) PCT No.: PCT/FR11/51277

§ 371 Date: Feb. 13, 2013

(30) Foreign Application Priority Data
Jun. 4, 2010 (FR) 10/02387

(51) Int. Cl. H05B 37/02

(52) U.S. Cl. CPC H05B 37/02
USPC 315/312

(57) ABSTRACT

System of beacons comprising a beacon (1) provided with an electric energy supply module (11), a radio communication module (12), a logic processing unit (13) comprising a memory and a clock synchronized with a reference clock, the electric energy supply means (11) comprising an electric energy generator (110) and an energy storing means (111).

The present invention relates to the technical realm of networks of programmable entities, and more particularly signaling entities such as light beacons.

“Programmable entity” is understood here as being any communicating device configured to act in accordance with data that are transmitted to it or that are programmed in it.

The usefulness of such beacons is widely recognized. Practice has shown the need for them in different domains, including:
safety, such as marking out a dangerous area;
guidance, such as marking an access road;
traceability, such as tracking a product on a production line;
identification, such as locating a mobile element in a defined environment;
economical lighting, such as a lighting system that can be activated by detecting the presence of people;
entertainment, such as ambient lighting for a ceremonial event;
or more generally, signaling.

In general, beacons are used as actuators or light and/or sound indicators. Said beacons are commonly deployed in interior or exterior environments, simple or complex architecture, such as a hall, a construction site, a room, a body of water, a ski resort, or a parking lot.

These beacons are generally set up in wireless networks by means of a communication system, generally short range.

To illustrate various beacon solutions, in particular one can refer to American patent application no. US 2008/0265799, which describes a lighting system composed of a plurality of lighting elements distributed in a wireless network that can be programmed by a remote control means.

Reference can also be made to international application WO 2009/003279, which proposes a system for controlling a lighting system sensitive to movement and to the speed of movement of a user in the environment where this setup is deployed. The lighting system is composed of a plurality of entities communicating by radio link; the status (light intensity, lighted or turned off) of these entities depends on data received from a plurality of sensors, or data that are transmitted from another entity.

The known methods and systems can be improved, particularly because they do not enable:
an inter-beacon synchronization (i.e., an intra-network synchronization of beacons) without reference to an external clock;
a deployment of the network of beacons irrespective of the environment (interior or exterior);
electric energy self-sufficiency for the beacon;
advanced programming of the beacons and not just simple instructions like “turn on”/“turn off”;
radio communication adapted to the deployment environment of the network of beacons.

An object of the present invention is to overcome these limitations, as well as the disadvantages of the methods and devices of the prior art.

Another object of the present invention is to propose a network of signaling entities that are energy self-sufficient in operation.

Another object of the present invention is to produce a network of synchronous signaling entities.

Another object of the present invention is to produce a network of signaling entities that are simultaneously or individually programmable.

A first aspect of the invention relates to a system of beacons comprising a beacon comprising an electric energy supply module, a radio communication module, a logic processing unit, said logic processing unit comprising a memory, a clock synchronized with a reference clock, said electric energy supply means comprising an electric energy generator and an energy storing means.

To that end, according to a second aspect, the invention relates to a signaling method comprising a beacon provided with an electric energy supply module, a radio communication module, a logic processing unit, said method comprising
a step of transforming one form of energy into electric energy;
a step of storing electric energy;
a step of synchronizing a clock, included in the logic processing unit, with a reference clock;
a step of executing, by the beacon, a program of instructions included in a memory included in the logic processing unit.

Other characteristics and advantages of the invention will appear more clearly and in more detail from the following description of preferred embodiments, provided with reference to the appended drawings in which:

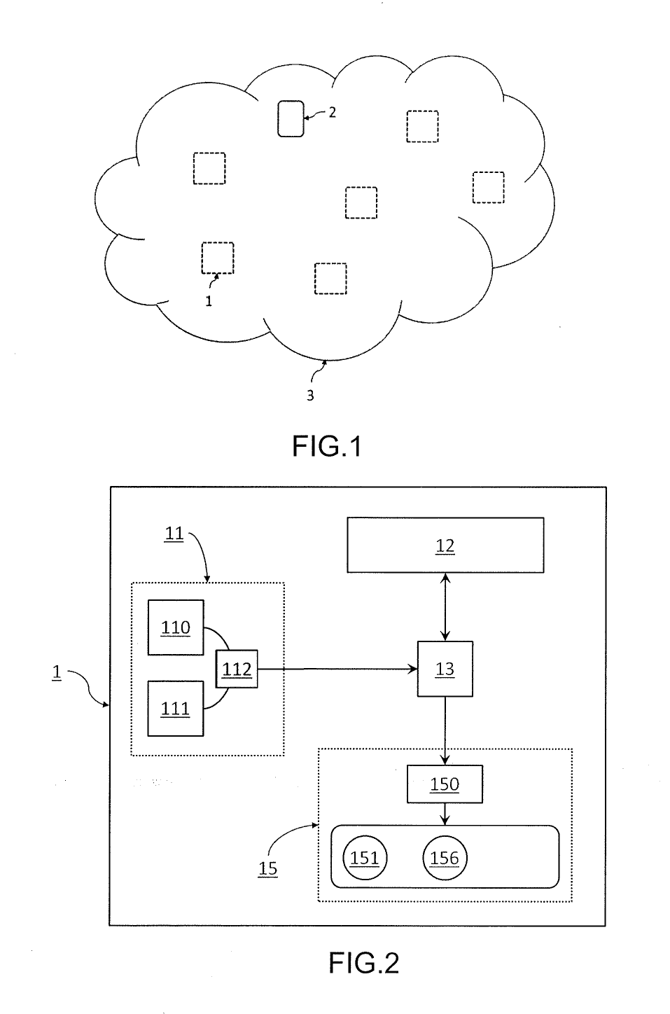

FIG. 1 diagrammatically illustrates an environment marked out by a system of synchronous self-contained light beacons set up in wireless network;

FIG. 2 diagrammatically illustrates a non-limiting functional representation of a communicating self-contained light beacon; and

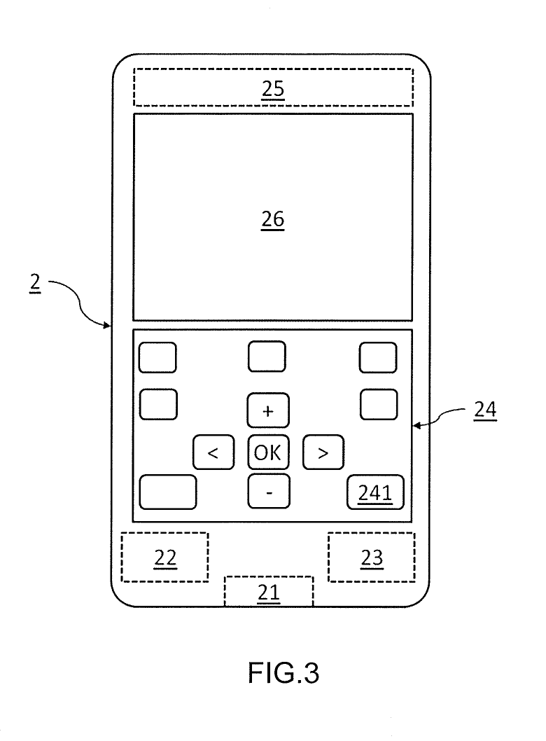

FIG. 3 diagrammatically illustrates a non-limiting functional representation of a control means of beacons.

The following description will be provided with reference to light beacons. This type of beacon is in no way limiting. In particular, other types of beacons, auditory for example, or more generally actuators, can be used. In other words, light beacons are given here only by way of example, illustrating actuators making it possible to act on lighting elements, according to data that are transmitted to them or programmed in them.

Therefore, light beacons are given here only by way of example and the invention can cover very many applications by replacing the lighting elements with other functional elements (for example, emission of a sound, ordering a movement, an action, or a measurement).

With this perspective, FIG. 1 represents a set of light beacons 1 controllable by a control means 2.

The network of light beacons 1 covers an environment 3 that can be interior or exterior. A construction site, a hall, the face of a wall, a museum, a room, a factory, a commercial sign, a parking lot, a landing strip, a railway station, or a park are examples of the environment 3. The network of light beacons 1 can be more or less dense in said environment 3, depending on the desired spatial coverage, and the range of wireless connectivity (Bluetooth™, Wi-Fi, infrared, ZigBee, Home RF, HiperLAN, HiperMAN, WiMAX, Wireless LAN, for example) of the beacons 1.

With reference to FIG. 2, it can be seen that the light beacon 1 comprises:
an electric energy supply module 11;
a radio communication module 12 (transmit/receive) powered by the electric energy supply module 11 and fitted, in particular, with an antenna and a data transmitting/receiving circuit;
a logic processing unit 13, such as a micro-controller, comprising in particular input/output ports, a calculator, a memory and a clock, and powered by the electric energy supply module 11; and
a lighting module 15 comprising at least one lighting element 151, 156 capable of emitting light when an electric current passes through it.

The electric energy supply module 11 preferably comprises
a generator 110 of electric energy; and
energy storage means 111 enabling at least a portion of the electric energy produced by the generator 110 to be stored.

In a preferred embodiment, the electric energy generator 110 is a photovoltaic generator (including photovoltaic solar cells) enabling electric energy to be generated from the light to which it is exposed. The energy storage means 111 is responsible in this case for storing at least a portion of the electric energy produced, which can then be used in the absence of light.

As a variant or in combination, the electric energy supply module 11 comprises any other energy recovery system capable of exploiting the variations in the physical state of the environment of the beacon 1, such as biomechanical, piezoelectric, thermoelectric, pyroelectric, barometric, magnetic, or metabolic, for example.

More generally, the generator 110 can be considered as any device capable of transforming one form of energy (light, heat, mechanical or chemical energy, for example) into electric energy.

The energy storage means 111 can comprise storage means that are:
electrochemical, such as batteries, storage batteries or more generally electrochemical accumulators;
capacitive, such as condensers or super-capacitors;
electromagnetic, such as inductances; or
inertial, such as inertia wheels.

The choice of appropriate components for the electric energy supply module 11 is left to the free choice of a person skilled in the art based on:
the performance of said components (output of the electric energy generator 110, ratio of stored energy to recovered energy of the energy storage means 111, for example);
the total electric power required by the beacon 1; and
a plurality of amenities (for example, size, design, cost).

Advantageously, the electric energy supply module 11, comprising an electric energy generator 110 and energy storage means 111, allows the beacon 1 to operate in energy self-sufficiency for a long period without interruption and without replacement of the internal elements.

Moreover, the electric energy supply module 11 comprises a DC/DC (direct/direct) converter 112 arranged to deliver constant output voltages, isolated from the voltage at its input, to the logic processing unit 13, and preferably under control of said unit, to the radio communication module 12, and to the lighting module 15. By way of example, the output voltage of the converter 112 can be 3.3 V with a maximum current of 100 to 500 mA, stabilized with an output voltage of several millivolts to several volts from the energy storage means 111.

The DC-DC converter 112 further enables the management of charging the energy storage means 111 with the electric energy produced by the electric energy generator 110.

With regard to the lighting module 15, it comprises:
a controller (driver) 150 controlled by the logic processing unit 13; and
a plurality of lighting elements 151, 156.

The controller 150 is configured to:
receive and interpret commands (for example, designated lighting elements; off-on status; intensity; color) that are transmitted to it from the logic processing unit 13 via its ports; and
apply said interpreted commands to the lighting elements 151, 156 concerned by said commands.

Preferably, the lighting elements 151, 156 are of low electrical consumption and enable RGB (red green blue) illumination and/or a plurality of levels of lighting intensity. By way of non-limiting example, the lighting elements 151, 156 are RGB light-emitting diodes (LEDs), luminescent diodes, laser diodes, discharge lamps, or more generally any device used as a light source.

The logic processing unit 13, provided with a processor, an A/D (analog/digital) converter, a non-volatile memory and a clock, and preferably of very low electric consumption, makes it possible to:
change, via the controller 150, the status of the lighting elements 151, 156 based on a program of instructions previously loaded into its memory or instructions that are communicated to it. To do this, the logic processing unit 13 sends signals, preferably governed by pulse width modulation (PWM)—by way of illustration, we cite PWM signals modulated at several hundred Hz with cyclical ratio values from 0 to 100% or also signals governed by any other type of control (for example, voltage, current)—via its output ports, making it possible to modulate the color and intensity of the lighting elements 151, 156; and
manage the incoming/outgoing communications to and from the beacon 1 via the radio communication module 12.

Preferably, the logic processing unit 13 further comprises at least one reserve output port for future use.

Implementing the aforementioned modules, the operation of a beacon 1 comprises several phases:
an initialization phase that takes place, for example, when it goes into operation or is inserted into a network of beacons 1 (for example, assignment of an identifier, verification of participation in a group of beacons, detection of adjacent beacons, setting of the emission power, initialization of the parameters of the logic processing unit 13);
a configuration phase, for example, for loading a program of instructions; and
a phase of executing a certain program composed of animation sequences, preferably organized in cycles.

Preferably, a light beacon 1 includes a plurality of cycles in its memory. A cycle comprises a plurality of successive sequences, each sequence taking place over a period of time specific to it and comprising information concerning the lighting elements 151, 156. In one embodiment, a sequence is defined by
one of 256 or more colors;
an intensity on a scale of from 0% to 100%; and
a duration, preferably expressed in a base unit whole number of the clock of the logic processing unit 13, the color and intensity remaining constant during that time period.

By way of illustration, following is a cycle C1 composed of 13 successive sequences S1-S13 to be executed by a light beacon 1 (the base unit of the clock of the beacon 1 is assumed to be a millisecond):
S1: duration of 500 ms, intensity 0%
S2: duration of 200 ms, color red, intensity 50%
S3: duration of 500 ms, color blue, intensity 80%
S4: duration 1 second, color yellow, intensity 100%
S5: duration 300 ms, color green, intensity 90%
S6: duration 300 ms, color red, intensity 80%
S7 to S13: duration 300 ms, color white, intensity dropping in steps of 10%;
return to S1: duration of 500 ms, intensity 0%.

In this example, an empty sequence (without altering statuses) of 100 ms may possibly be added to the duration of C1=4900 ms to reach a full duration of 5 seconds.

More generally, the duration of a sequence and/or a cycle of sequences corresponds to n (n being a whole number) times the base unit of measure of a clock of the logic processing unit 13.

To execute a cycle, the output ports of the logic processing unit 13—connected to the controller 150 of the lighting elements 151, 156—are preferably controlled by pulse width modulation (PWM) or by any other type of control (for example, voltage, current). By way of example, assuming the lighting elements 151, 156 are RGB LEDs, three output ports of the logic processing unit 13 make it possible to control the color, intensity and status (on/off) of the RGB LEDs, in accordance with the content of sequences being executed. As a result, the light beacon 1 can execute sequences of lighted animations that vary in color and intensity.

In one particular embodiment, the lighting elements 151, 156 are animated differently. This can be achieved:
by using two different animation cycles, stored in the memory of the logic processing unit 13; or
by duplicating the same animation cycle and then making changes to it (for example, offset, inversion, or modification of an animation sequence) by means of the controller 150.

In a preferred embodiment, by means of an on-board software application, the logic processing unit 13 is capable of executing the following operations, according to instructions that will be communicated to it via its radio communication module 12:
interrupt an animation cycle,
pause/resume an animation cycle,
go forward/backward in an animation cycle,
go to the next animation cycle,
return to the preceding animation cycle.

Advantageously, the modules of the beacon 1 are mounted in a single case that forms the housing of the beacon 1, which can also be provided with a wall base or means of direct attachment to a horizontal or vertical support.

The light beacons 1 can be controlled and configured separately or simultaneously by the remote control means 2, which is provided with (see FIG. 3):
a radio communication (transmit/receive) module 25 enabling communication to be established with at least one light beacon 1 of the environment 3;
a central processing unit 23 (a microprocessor or more generally a processor) provided with a memory and a clock and comprising means (in the form of programs) making it possible to request access and/or the modification of at least one configuration datum related to at least one light beacon 1 of the environment 3;
data entry means 24 (for example, a real or virtual keyboard, or selection buttons);
a wired or wireless communication interface 21 (for example, a USB port, an Ethernet port, a Bluetooth interface, an infrared interface); and
an electric energy source 22 supplying all of the electronic circuits at the control means 2.

It should be noted that the expression “central processing unit” includes here any device incorporated in a programmed processor to provide one or more predetermined functions, or any software application (program or subprogram, plug-in) implemented on a processor, independently or in combination with other software applications.

Preferably, the control means 2 further comprises a display means (screen) 26. In one embodiment, the display means 26 is a touch screen.

The communication interface 21 is arranged to enable communication of the control means 2 with a user terminal such as, for example, a computer (mobile/fixed), a Smartphone, a PDA (personal digital assistant), or a portable telephone.

In one embodiment, the electric energy source 22 is an electric battery (or also the storage battery) rechargeable via the communication interface 21 (rechargeable via a USB port, for example).

The communication with a user terminal, via the communication interface 21, allows the user terminal, by means of an appropriate computer program, to load into the memory of the control means 2, a configuration (instruction program) intended for one or more light beacon(s) 1.

In one embodiment, the control means 2 is itself a user terminal. By way of examples, the control means 2 is
a computer, preferably mobile, having radio connectivity (for example, Bluetooth™, Wi-Fi, ZigBee, Home RF, HiperLAN, Wireless LAN) compatible with the connectivity of the light beacon 1 network, and an appropriate computer application for controlling the light beacons 1, is installed there;
a Smartphone having radio connectivity (for example, Bluetooth™, Wi-Fi, ZigBee, Home RF, HiperLAN, Wireless LAN) compatible with the connectivity of the beacon 1 network, and an appropriate computer application for controlling the light beacons 1, is installed there.

Preferably, the computer program for programming the light beacons 1 comprises a graphic user interface (GUI) enabling the display and/or simulation of animation sequences by the light beacons 1. Advantageously, said graphic user interface makes it possible to produce a physical representation of the location of the beacons 1 and to graphically program lighted animations.

In the implementation illustrated in FIG. 2, the control means 2 is a remote control enabling the simultaneous or individual control of the light beacons 1 comprising the wireless network.

In another embodiment, the control means 2 is a mobile terminal for establishing communications sessions with the beacons 1 and collecting information from them or transferring a program of instructions to them from a configuration computer program.

Preferably, the control means 2 includes default animation sequences in its memory.

During its communication with a light beacon 1, the control means 2 makes it possible:
to collect information from the light beacon 1 (for example, its identifier, the level of energy available in its energy storage means 111, the radio transmission power, the operational status of the lighting elements 151, 156, the number of the sequence/cycle in process of execution, the version of at least one on-board computer application, the relative/absolute position of the beacon in the network, whether or not it is a coordinating beacon);
to send orders to the beacon 1 (for example, interruption of a cycle, standby, pause, skip cycle, execution of a cycle, modify the radio transmission power, designation as coordinating beacon);
to load a program of instructions (animation sequences) into the memory of the light beacon 1;
to synchronize the clock of the light beacon 1 to its clock.

In particular, the control means 2 is capable of communicating simultaneously with a plurality of light beacons 1 (all or part of the network of beacons 1). Indeed, the control means 2 can be programmed to communicate with the light beacons 1 according to different modes, such as for example a grouped communication mode (a broadcast to all of the light beacons 1) in order to
control the color of the light emitted by the lighting elements 151, 156 of the beacons 1, in a cyclical manner by pressing on the buttons of the data entry means 24, for example;
control the intensity of the light emitted by the light beacons 1 in a range between a minimum threshold and a maximum threshold, via the buttons of the data entry means 24, for example;
validate (OK button, for example) a command to transmit to a plurality of light beacons 1;
change the status (for example, standby/operate) of a plurality of light beacons 1, via the button 241 of the data entry means 24, for example;
download a program to the light beacons 1 from the memory of the control means 2. A “DNL” (download) key, for example, makes it possible to trigger the downloading to the light beacons 1 of a configuration selected from the memory of the control means 2.

In combination, the control means 2 enables a selective communication mode authorizing a selective control of the light beacons 1 (addressing a particular group of light beacons 1, or a single light beacon 1).

In one embodiment, when a light beacon 1 is placed in operation for the first time, for example, it is configured to set to zero all of the output ports of the logic processing unit 13 (so no sequence is transmitted to the controller 150), and to await an initialization request by the control means 2.

To start up a light beacon 1 that does not yet have an identifier, the beacon 1 is first selected during an initialization step by interpretation of a radio signal transmitted, preferably at low power, by the control means 2 in order to require said control means to communicate only with a beacon situated in proximity (located within x cm of the control means 2, for example, where x is a predetermined positive real number). This selection by proximity makes it possible to selectively initialize a beacon 1, or a particular group of beacons 1. When an initialization request is received by the beacon 1, it then awaits the assignment of an identifier by the control means 2. The control means 2 then transmits an identifier to the beacon 1. In response, said beacon can emit:
a particular light and/or audio signal to verify that it has been initialized; or
a radio signal to the control means 2 to confirm its proper initialization particularly by communicating the identifier that was assigned to it.

This process can also be performed for changing the identifier of a beacon 1 or its participation in a group.

As a variant, a unique identifier is assigned to each beacon 1 when it is manufactured, said identifier being stored in its memory.

To resume operation (particularly following a discharge of the energy storage means 111 in the absence of light, for example), the beacon 1 can proceed in accordance with different methods, for example:
going into standby mode, while periodically (every 100 ms, for example) monitoring for signals sent to it, without executing any cycle;
executing, possibly after a delay, a restart cycle selected from among the cycles recorded in its memory, or resuming the last cycle that was being executed, when synchronization with the control means 2 is established.

The choice of these options can be programmed in advance by means of the computer program during the configuration phase of the beacon 1 by the control means 2.

Among other things, the control means 2 makes it possible to:
request an interrupt. To achieve this, a light beacon 1 is periodically monitoring (for several milliseconds, for example, every 100 ms). This interrupt request comprises at least
   an identifier of a beacon 1 or a group of beacons 1 concerned by said interrupt request;
   an identifier of the respective action to be executed, for example, the execution of a predefined cycle, going on standby, waiting time prior to the execution of this interrupt;
sending a configuration of cycles to one or more beacons 1. Indeed, during the execution of sequences or even on standby, the beacon 1 is periodically monitoring (several milliseconds, for example, every 100 ms). Upon receipt of this configuration request, in particular comprising the identifier of the beacon(s) 1 concerned, said beacons
   acknowledge the configuration request sent from the control means 2, which in particular comprises the cycle or cycles to reprogram;
   are placed in continuous receiving mode for a predefined time making it possible to receive the reconfiguration frames for a cycle, the maximum size of the frame being predefined. Said frames are preferably provided with a code for confirming the integrity of the data received;
   they confirm the integrity of the reconfiguration information received
request parameters concerning one or more beacons 1 (identifier of the beacon 1, identifier of the cycle in process of execution, current mode of operation (execution/standby), level of the battery, production level of the photovoltaic cells, version number of the operating program of the beacon 1, for example).

In one embodiment, the beacon 1 confirms or acknowledges receipt of a command/message transmitted to it, by emitting a specific light and/or audible signal. For example, a beacon can blink green for a predetermined time to signal that the loading of a program of instructions into its memory has been correctly performed.

In another embodiment, confirmation of the integrity of the information sent to it is done automatically. Indeed, the control means 2 or a coordinating beacon is arranged to send a request concerning the proper receipt of information (for example, a reconfiguration) addressed to a particular beacon 1. In this case, said beacon alone will respond to this request by communicating its identifier, as well as a parameter enabling the detection of transmission errors (CRC—cyclic redundancy check—for example) of the sequence received. This makes it possible to verify, upon receipt of this response by the control means 2 or the coordinating beacon, whether the interaction with said beacon 1 terminated correctly.

In one embodiment, a particular beacon 1 can assist the control means 2 in relaying or sending, under an order from the control means 2, a message to other beacons 1, said beacon acting as coordinating beacon capable of replacing the control means 2 in some of its functions, particularly the synchronization of the beacons 1.

Advantageously, a coordinating beacon 1 allows the control means 2 to communicate with beacons 1 not included in the radio coverage zone of the control means 2. In this case, it is preferable for each beacon 1 to be identified in the network by a unique identifier known to the control means 2, to the coordinating beacon and preferably to other possibly adjacent beacons 1 according to the topology of the network.

Various methods (radio direction finding, triangulation, decrease in power) can be implemented to estimate the spatial position of a coordinating beacon 1 in a network of beacons 1. By way of example, we can cite the use of the power of a signal exchanged between the beacons 1 to deduce therefrom an estimate of the distances between them.

Moreover, the network of communicating beacons 1 enables the synchronization of the clocks of at least one group of beacons 1
at the initiative of a coordinating beacon 1 designated by the control means 2; or
regularly without the intervention of the coordinating beacon 1.

Advantageously, the synchronization of the clocks of at least one group of beacons 1 can be achieved by a coordinating beacon 1, when the control means 2 is out of range of said beacons 1 or is connected at that time to a remote user terminal that includes a configuration software, for example. More generally, the coordinating beacon 1 can serve as synchronization clock in the absence and/or in the presence of the control means 2.

The synchronization of the beacons 1 (or more precisely, of the clocks of the beacons 1) is a key element on which is based the proper operation of the animations, or more generally the actions produced by the beacons 1. These beacons 1 represent a distributed system, i.e., a set of communicating entities connected in a network.

It is commonly accepted that two clocks starting in phase never remain synchronous. A short-term variation in environmental factors (for example, temperature, pressure, altitude, power supply voltage) or long-term variations such as wear or fatigue of one clock with respect to another, result in more or less significant deviations (up to several seconds per day). Synchronization among the beacons 1 is therefore essential. The effect of this synchronization is to synchronize animation cycles and sequences of all of the beacons 1. To that end, the beacons 1 must have a common concept of time.

An internal synchronization (internal to the network of beacons 1) based on the sharing of a global clock, particularly that of the control means 2 or a coordinating beacon 1, enables all of the clocks of the beacons 1 to be kept synchronous. In other words, the clocks of the beacons 1 have one and the same shared global clock as a common time reference.

Advantageously, the synchronization method makes it possible to converge all of the clocks of the beacons 1 into the same time reference. In one embodiment, this time reference can be different from real time. In this case, it is only a reference satisfying a certain alignment among all of the clocks of the beacons 1. Upon receipt of the synchronization frame, the clocks of the beacons 1 attempt to align themselves as much as possible with the rhythm (frequency) of the reference clock. For example, synchronization frames can be sent every second, or at the start of each cycle.

In one embodiment, upon receipt of a synchronization frame, a beacon 1 finds the oscillation frequency of the reference clock (the frequency of the control means 2 or that of a coordinating beacon 1) by means of a phase-locked loop (PLL). Said PLL enables the frequency of the clock of the beacon 1 to be slaved to the frequency of the reference clock by means of synchronization frames. As a result, the receiving beacon 1 governs the rhythm of its clock.

In one embodiment, the synchronization frame includes the number of units of time (seconds, for example) elapsed since the start of a cycle or since another reference chosen by the control means 2, for example.

In another embodiment, the synchronization frame includes a number of timestamps of the clock of the control means 2, recorded in a predefined time window (for example, based on the time of the user terminal to which the control means 2 is connected).

It should be noted that the transit time of the radio signals can contribute to uncertainty about the accuracy of synchronization of the beacons 1. However, this effect is negligible due to the propagation speed of the radio signal, taking into account the relatively modest spatial extent of the network of beacons 1. Corrections (primarily compensations) can be made to the content of the synchronization frames in order to take into account disturbances due to the transmission channel.

The processing time of the synchronization frames (in the case of a chained network, for example) by the beacons 1 can be compensated at each beacon 1 (one node of the network) so that it does not affect the accuracy of the synchronization of all of the clocks of the beacons 1. Indeed, the delay resulting from passing through a beacon 1 can be corrected before the retransmission of the synchronization frame to another beacon 1 (another node of the network).

In one non-limiting embodiment, a method of synchronizing beacons 1, preferably organized in a star network, comprises:
a step of transmitting a synchronization frame, during a time t, according to a period T (t=1 ms, T=1 s, for example), by the control means 2 or by a coordinating beacon 1;
a step of alignment, by a beacon 1, of its clock according to the content of the synchronization frame upon receipt of said frame;
a step of placing the beacon 1 in “awaiting synchronization” mode during the time 2*t around the period T, thus leaving a duration of t before and after the expected moment of receipt of a synchronization frame;
if no synchronization frame is received by the beacon 1, then a step of placing the beacon 1 in continuous reception for a duration T+t, until the receipt of a synchronization frame;
if no synchronization frame is received by the beacon 1, then a step of placing on standby for a duration of n*T (where n is a predetermined whole value), until resumption of the preceding step.

In one embodiment, the network of beacons 1 comprises:
a star network around the control means 2;
a star network around a coordinating beacon 1;
a plurality of star networks, respectively, around a plurality of coordinating beacons that are themselves around the control means 2.

Advantageously, in a star topology, the beacons 1 are ordered to receive at the same time the synchronization frames transmitted from the control means 2 or from a coordinating beacon 1. In particular, this is conducive to high-resolution synchronization, as well as the energy self-sufficiency of the beacons 1 (no retransmission of synchronization frames, and therefore no excessive use of the logic processing unit and radio link).

If the network of beacons 1 has a ring, tree, bus or chain topology, it is preferable to take into account the arrival times of the synchronization frames at the beacons 1 (in particular to compensate for the latency time induced by the processing and/or the propagation of the synchronization frames).

In one embodiment, in order to confirm the synchronization of the beacons 1, the control means 2 or the coordinating beacon 1 sends a request for verification of synchronization to just one beacon 1 at a time. In this case, only the destination beacon 1 will respond to confirm its proper synchronization by communicating its identifier, as well as a timestamp of the time elapsed since its last synchronization or any other parameter making it possible to calculate and verify this synchronization.

This allows the control means 2 or the coordinating beacon to verify, upon receipt of this information, that the beacon 1 in question is properly synchronized, by a tolerance that will take into account the uncertainties related to calculation times required by the beacon 1 and by the control means 2 or the coordinating beacon 1.

In another embodiment, a beacon 1 responds to a request for verification of synchronization within a time period given to it. Said time period can be predetermined during the configuration phase, or as a function of the beacon 1 identifier if it knows the identifiers of the other beacons. Advantageously, this makes it possible to sequence in time the responses from the beacons 1 to a request for verification of synchronization sent simultaneously to a group of beacons 1. In particular, this makes it possible to avoid interference of the different responses from the queried beacons 1. As a variant, the beacons 1 transmit at slightly different frequencies. More generally, the communication method between the control means 2 and the beacons 1 includes a group concept, enabling the control means 2 to address a plurality of beacons 1 without the risk of interference in the radio exchanges with said beacons 1. The LBT (listen before talk, or listen before transmit) protocol is an example of such a method.

Preferably, requests for verification of synchronization are sent periodically by the control means 2 or a coordinating beacon to each beacon 1 (for example, every m synchronization frames, where m is a predetermined whole number) so as to query all of the beacons 1 in a given period of time.

Said period can be chosen based on the drift of the clocks of the beacons 1.

Preferably, the synchronization method of the beacons 1 does not influence the energy self-sufficiency of the beacons 1 (minimal use of the radio communication module 12 of the beacons 1, for example), which is mostly intended for the lighting elements 151, 156.

It should be noted that a clock outside the network of beacons 1 (for example, GPS—global positioning system) can also be used, but to the detriment of the energy self-sufficiency of the beacons 1.

In a situation where one or more beacons 1 are not synchronized, the control means 2 or a coordinating beacon 1 can decide on a specific action. For example, said action can be
recording the identifiers of the unsynchronized beacons 1. This stored information can then be communicated to the user for purposes of general information, statistics and maintenance;
for example, the signaling of the unsynchronized beacon 1 to the user by ordering a particular animation sequence for said beacon 1.

It should be noted that a malfunction of a beacon 1 (for example, out of sync, computer bug) affects only that beacon 1, without affecting any of the other beacons 1.

When a beacon 1 is identified in a network, it awaits synchronization for a period of time at least equal to the time separating two synchronization frames, so as then to be able—if appropriate—to start the execution of its lighted animation in synchronization with the lighted animation in progress of the other beacons 1.

If for any reason—for example, following a discharge of the energy storage means 111 in the absence of light—a coordinating beacon 1 is unable to transmit synchronization frames, the coordinating beacon function is then assigned to another beacon 1, according to a process of choice related to its identification number, its spatial position, or any other decision criterion previously programmed by the computer program during the phase of configuring the beacons 1 by the control means 2. In particular, this makes it possible to ensure the continuity of the synchronization of the network of beacons 1 in the event of failure of a coordinating beacon 1. A coordinating beacon 1 is deemed to be failing when the beacons 1 of its group do not receive synchronization frames for a predetermined period of time or do not receive p successive synchronization frames (where p is a predetermined whole value).

In one embodiment, the program of instructions loaded into the memory of a beacon 1 depends on data collected from a system of sensors. An RFID device, an ambient light detector, a gyroscope, a clinometer, a microphone, a thermometer, a pressure gauge, a photometer, a hygrometer, a rain gauge, a level detector, a presence detector, a position switch, a clock, a speedometer, an antenna, or a smoke detector are examples of elements of the system of sensors. By way of example, this makes it possible to execute a lighted animation based on the time of day, presence/absence of people, and speed of movement of a person, for example. It should also be noted that the control means 2 or the coordinating beacon 1 can, unconditionally or possibly upon receipt of information produced by the system of sensors:
order the change from one animation cycle to another cycle on one or more beacons 1 of the network; or
make changes to the sequences of animations, for example, adapting the light intensity (or hue) to the ambient light (or sound) around a beacon 1.

Other actions can be coupled to the lighted animation of the network of beacons 1 (opening a door, reading an audio file, triggering an alarm, for example).

The method that has just been described has a certain number of advantages. It enables the advanced management (advanced configuration of the beacons 1), dynamic programming (a network that can be programmed at any time), and a synchronization of the light beacons 1 (synchronized lighted animation).

1. System of beacons comprising a beacon (1) provided with an electric energy supply module (11), a radio communication module (12), a logic processing unit (13), said system characterized in that said logic processing unit comprises a memory and a clock synchronized with a reference clock, and said electric energy supply means (11) comprising an electric energy generator (110) and an energy storing means (111).

2. System according to claim 1, characterized in that it further comprises a control means (2) of the beacon (1), said control means (2) comprising a radio communication module (25), input means (24) and a central processing unit (23) including a clock and a memory.

3. System according to claim 2, characterized in that the clock of the control means (2) is the reference clock.

4. System according to claim 2, characterized in that the control means (2) further comprises a communication interface (21) arranged to allow the communication of said control means (2) with a user terminal.

5. System according to claim 4, characterized in that the user terminal is arranged to load, via a computer program, a program of instructions into the memory of the control means (2).

6. System according to claim 2, characterized in that the control means (2) is arranged to allow the loading of a program of instructions into the memory of the beacon (1).

7. System according to claim 5, characterized in that the program of instructions is dependent on data collected from a system of sensors.

8. System according to claim 2, characterized in that the control means (2) is arranged to synchronize the clock of the beacon (1) with its clock.

9. System according to claim 1, characterized in that it comprises a set of beacons (1) set up in a wireless network.

10. System according to claim 9, characterized in that the network comprises a coordinating beacon (1), the clock of which serves as reference clock instead of the clock of the control means (2).

11. Signaling method by means of at least one beacon (1) provided with an electric energy supply module (11), a radio communication module (12) and a logic processing unit (13), which method is characterized in that it comprises:
a step of transforming one form of energy into electric energy;
a step of storing electric energy;
a step of synchronizing a clock, included in the logic processing unit (13), with a reference clock;
a step of executing, by the beacon (1), a program of instructions included in a memory included in the logic processing unit (13).

12. Method according to claim 11, characterized in that it comprises a step of communication of the beacon (1) with a control means (2).

13. Method according to claim 12, characterized in that the communication step comprises a configuration step allowing a program of instructions to be downloaded from the control means (2) to the memory of the beacon (1).

14. Method according to claim 11, characterized in that the synchronization step comprises:
the receipt of a synchronization frame by the beacon (1);
the slaving of the frequency of the clock of the beacon (1) by means of the synchronization frames received.

15. Method according to claim 14, characterized in that the synchronization step further comprises a step of verification of synchronization.
